(19) United States
(12) Patent Application Publication
(10) Pub. No.: US 2014/0104745 A1
(43) Pub. Date: Apr. 17, 2014

(54) MIM CAPACITOR AND FABRICATION METHOD THEREOF

(71) Applicant: SHANGHAI HUALI MICROELECTRONICS CORPORATION, Shanghai (CN)

(72) Inventor: Chunsheng ZHENG, Shanghai (CN)

(73) Assignee: SHANGHAI HUALI MICROELECTRONICS CORPORATION, Shanghai (CN)

(21) Appl. No.: 13/730,372

(22) Filed: Dec. 28, 2012

(30) Foreign Application Priority Data
Oct. 12, 2012 (CN) 201210388711.1

(51) Int. Cl. H01G 13/00; H01G 2/20

(52) U.S. Cl. CPC H01G 13/00; H01G 2/20
USPC 361/275.1; 29/25.42

(57) ABSTRACT

A method of fabricating a metal-insulator-metal (MIM) capacitor is disclosed, wherein after capacitor trenches have been formed in a dielectric layer by dry etching, a wet etching process is further applied to the dielectric layer to etch the one or more capacitor trenches. By taking advantage of an isotropic characteristic of the wet etching process, the corners of the one or more capacitor trenches are rounded after the wet etching. Accordingly, a lower electrode, an insulator and an upper electrode formed thereafter over the dielectric layer and the surfaces of the one or more capacitor trenches will also have similar rounded corners at corresponding positions. Such design may substantially reduce the risk of occurrence of point discharge in the resulting MIM capacitor and hence may improve the operational reliability of the capacitor.

### CROSS-REFERENCES TO RELATED APPLICATIONS

This application claims the priority of Chinese patent application number 201210388711.1, filed on Oct. 12, 2012, the entire contents of which are incorporated herein by reference.

### TECHNICAL FIELD

The present invention relates to semiconductor fabrication, and more particularly, to a metal-insulator-metal (MIM) capacitor and a fabrication method thereof.

### BACKGROUND

Capacitors are essential constituent components of integrated circuits and have been widely used in memory, microwave, radio frequency, smart card, high-voltage, filter and other chips. The most popular capacitors employed in chips are the ones having a metal-insulator-metal configuration that is parallel to the silicon substrate, wherein the metal is, such as copper or aluminum. The fabrication process of such capacitors is easy to be compatible with the metal interconnect process, and the insulator is formed of a dielectric material with a high dielectric constant, such as silicon dioxide or silicon nitride.

Chinese patent publication No. CN1208964A discloses a capacitor structure which is a plate capacitor having a single-layer metal-insulator-metal (MIM). In addition, many inventions of high-density capacitor structures, like the one disclosed by Chinese patent publication No. CN1635595A, are mainly focused on various approaches for achieving a higher capacitance density by increasing the number of parallel-connected capacitors per unit area (or per unit volume).

On the other hand, for MIM capacitors, how to substantially reduce the risk of occurrence of point discharge and hence improve the operational reliability of the MIM capacitors is also an issue to be addressed.

### SUMMARY OF THE INVENTION

The present invention is to provide a metal-insulator-metal (MIM) capacitor and a method of fabricating the MIM capacitor to effectively reduce the possibility of point discharge, and thereby improve the operational reliability of the capacitor.

To achieve the above objective, the present invention provides a method of fabricating a metal-insulator-metal (MIM) capacitor, the method includes the steps of

providing a substrate, the substrate having a dielectric layer formed thereon;

dry etching the dielectric layer to form one or more capacitor trenches therein;

wet etching the dielectric layer to round corners of the one or more capacitor trenches; and

forming in sequence a lower electrode, an insulator and an upper electrode over the dielectric layer and surfaces of the one or more capacitor trenches.

Optionally, in this method of fabricating a metal-insulator-metal (MIM) capacitor, the dielectric layer is formed of silicon dioxide.

Optionally, in this method of fabricating a metal-insulator-metal (MIM) capacitor, the wet etching process is performed by using diluted hydrofluoric acid (DHF) or buffered oxide etchant (BOE) for 5 seconds to 10 minutes.

Optionally, in this method of fabricating a metal-insulator-metal (MIM) capacitor, the dry etching process is performed with a pressure of 1 mTorr to 10 mTorr, a source radio frequency power of 100 W to 300 W, a bias RF power of 100 W to 300 W, an oxygen flow rate of 10 SCCM to 30 SCCM, a carbon tetrafluoride flow rate of 10 SCCM to 50 SCCM, a helium flow rate of 20 SCCM to 100 SCCM and a temperature of 40° C. to 50° C.

Optionally, in this method of fabricating a metal-insulator-metal (MIM) capacitor, the lower electrode and the upper electrode are formed of copper or aluminum.

Optionally, in this method of fabricating a metal-insulator-metal (MIM) capacitor, the insulator is formed of silicon dioxide or silicon nitride.

The present invention also provides a metal-insulator-metal (MIM) capacitor, including: a lower electrode, an insulator and an upper electrode, all formed over a dielectric layer and surfaces of one or more capacitor trenches, wherein the one or more capacitor trenches are round-cornered.

Compared to the prior art, after the capacitor trenches are formed in the dielectric layer by dry etching, the method of the present invention additionally employs a wet etching process to etch the dielectric layer, during which process the capacitor trenches are isotropically etched and thereby corners of the capacitor trenches are rounded. Accordingly, the lower electrode, the insulator and the upper electrode formed thereafter over the dielectric layer and over surfaces of the capacitor trenches will also have similar rounded corners at corresponding positions. Such a new design may substantially reduce the risk of occurrence of point discharge in the resulting MIM capacitor and hence improve the operational reliability of the capacitor.

### BRIEF DESCRIPTION OF THE DRAWINGS

FIG. 1 is a flow chart illustrating a method of fabricating a metal-insulator-metal (MIM) capacitor according to an embodiment of the present invention.

FIGS. 2A to 2D are schematic diagrams illustrating the device structures during various steps of the fabrication method according to an embodiment of the present invention.

### DETAILED DESCRIPTION

Advantages and features of the present invention will be apparent from the following description and the appended claims. Note that all the accompanying drawings are presented in a dramatically simplified form and are not precisely to scale, and they are provided to aid in convenience and clearness in describing embodiments of the invention solely.

The core concept of the present invention is to provide a metal-insulator-metal (MIM) capacitor and a fabrication method thereof. After one or more capacitor trenches are formed in a dielectric layer by dry etching, the method of the present invention additionally employs a wet etching process to etch the dielectric layer. During the wet etching process, the one or more capacitor trenches are isotropically etched and thereby their corners are rounded. Accordingly, a lower electrode, an insulator and an upper electrode formed thereafter over the dielectric layer will have similar rounded corners at corresponding positions, in this way substantially reducing the occurrence of point discharge in the MIM capacitor and hence improving the operational reliability of the MIM capacitor.

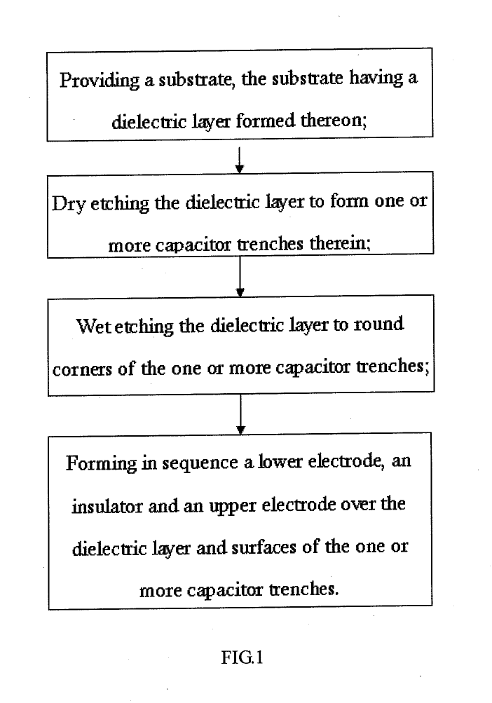

Referring to FIG. 1, the method of fabricating a MIM capacitor provided by the present invention includes the steps of:

Step S1: providing a substrate, the substrate having a dielectric layer formed thereon;

Step S2: dry etching the dielectric layer to form one or more capacitor trenches therein;

Step S3: wet etching the dielectric layer to round corners of the one or more capacitor trenches;

Step S4: forming in sequence a lower electrode, an insulator and an upper electrode over the dielectric layer and over surfaces of the one or more capacitor trenches.

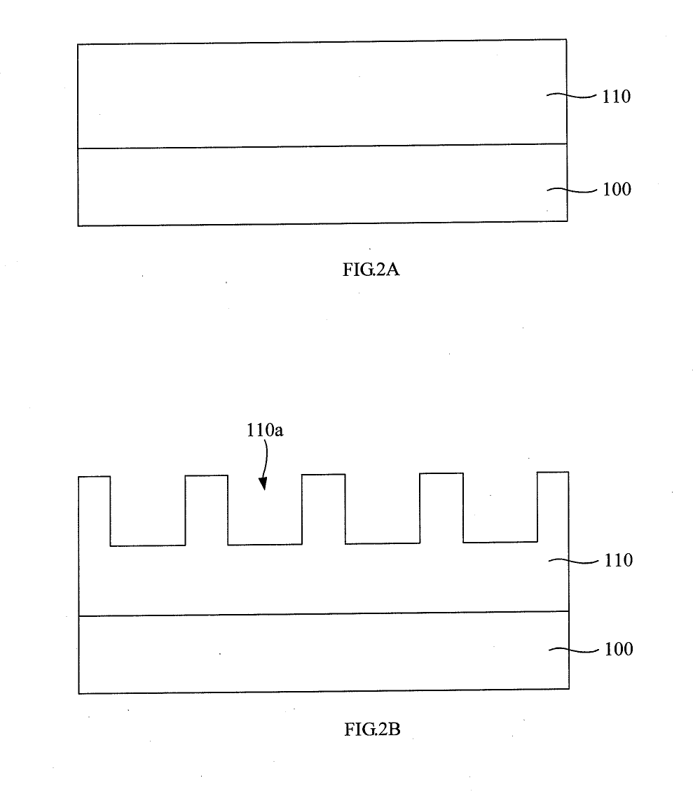

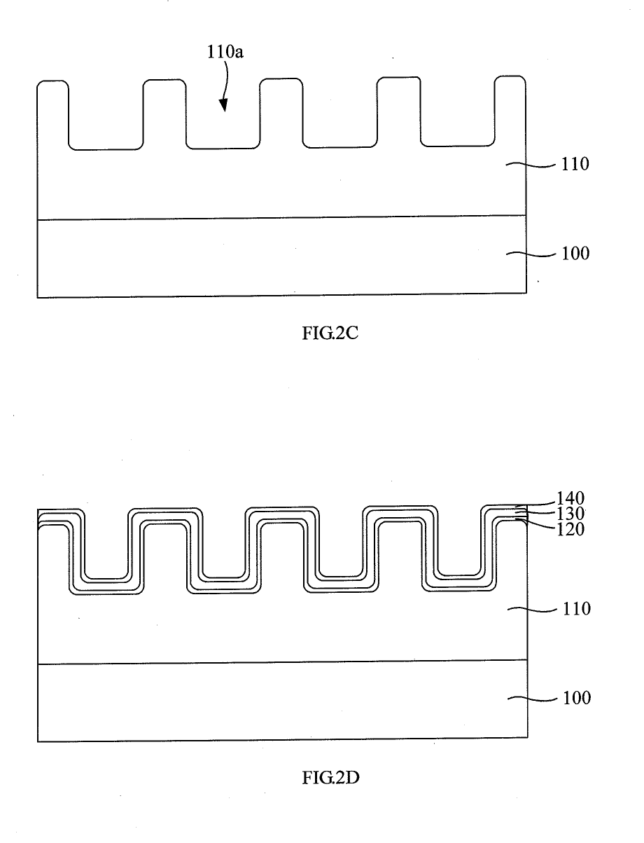

The MIM capacitor and the fabrication method thereof provided by the present invention will be further described below with reference to schematic cross-sectional views of FIGS. 2A to 2D.

As shown in FIG. 2A, the Step S1 is carried out first, wherein a substrate 100 is provided on which a dielectric layer 110 has been formed. The substrate 100 may also have some other known structures formed therein, which will not be specified herein.

Next, as shown in FIG. 2B, the Step S2 is performed to apply a photolithographic and dry etching process to the dielectric layer 110 to form one or more capacitor trenches 110a therein. Specifically, this step includes the following sub-steps: a) coating a photoresist layer (not shown in FIG. 2B) over the dielectric layer 110; b) patterning the photoresist layer by performing an exposure-and-development process thereon; c) dry etching the dielectric layer 110 using the patterned photoresist layer as a mask, wherein the dry etching process may be performed with a pressure of 1 mTorr to 10 mTorr, a source radio frequency (RF) power of 100 W to 300 W, a bias RF power of 100 W to 300 W, an oxygen flow rate of 10 SCCM (standard-state cubic centimeter per minute) to 30 SCCM, a carbon tetrafluoride (CF₄) flow rate of 10 SCCM to 50 SCCM, a helium (He) flow rate of 20 SCCM to 100 SCCM and a temperature of 40° C. to 50° C.; d) removing the patterned photoresist layer. As the dry-etch proceeds in an anisotropic manner, dimensions of the resulting capacitor trenches 110a can be precisely controlled. In addition, the one or more capacitor trenches 110a formed will have angular (or sharp) corners after this step.

After that, as shown in FIG. 2C, the Step S3 is carried out to wet etch the dielectric layer 110 so as to round the corners of the capacitor trenches 110a. The present invention etches the capacitor trenches 110a by taking advantage of an isotropic characteristic of the wet etching process. In other words, in the wet etching process, the capacitor trenches 110a are slightly trimmed, such that their corners are rounded and smoothed and hence the capacitor trenches 110a obtain a rounded profile.

For example, when the dielectric layer 110 is made of silicon dioxide, the wet etching process will be carried out by using diluted hydrofluoric acid (DHF) or buffered oxide etchant (BOE) for 5 seconds to 10 minutes. Note that, herein, as this step is performed for slightly trimming the capacitor trenches 110a, its duration time should not be long. Those skilled in the art may select a proper etchant and a corresponding etching duration to form corners with a practically needed angle. For example, but not limited to, when the dielectric layer 110 is made of silicon nitride, phosphoric acid may be correspondingly selected as the etchant for the wet etching process.

In addition, as the wet etching process can slightly deepen and widen the capacitor trenches 110a, capacitor trenches with a depth and width slightly smaller than the targeted dimensions may be formed by the dry etching process, such that these dimensions can be modified to the targeted ones by the subsequent wet etching process. For example, if the targeted depth of the capacitor trenches is in a range of 10 nm to 300 nm and the targeted width is in a range of 10 nm to 1000 nm, respectively, capacitor trenches with a depth in a range of 5 nm to 295 nm and a width in a range of 5 nm to 995 nm respectively may be formed after the dry etching process, then after the wet etching process which modifies the profile of the capacitor trenches and slightly deepens and widens the capacitor trenches at the same time, capacitor trenches with a depth and width within the respective targeted ranges can be obtained.

At last, as shown in FIG. 2D, the Step S4 is performed to successively form a lower electrode 120, an insulator 130 and an upper electrode 140 over the dielectric layer 110 and surfaces of the capacitor trenches 110a, so as to form the MIM capacitor. As described above, as the capacitor trenches 110a have rounded corners, the lower electrode 120, the insulator 130 and the upper electrode 140 formed will have similar rounded corners as well. Thus, the occurrence of point discharge in the resulting MIM capacitor is effectively reduced and thus its operational reliability is improved. In this step, the lower electrode 120 and the upper electrode 140 may be formed of copper or aluminum between which copper is preferred, by a sputtering or plating method. The insulator 130 may be formed of silicon dioxide or silicon nitride.

According to another aspect of the present invention, an MIM capacitor is also provided, which includes: a lower electrode 120, an insulator 130 and an upper electrode 130, all formed over a dielectric layer 120 and surfaces of one or more capacitor trenches 110a formed in the dielectric layer 120, wherein the capacitor trenches 110a are round-cornered trenches.

Obviously, those skilled in the art can make various modifications and variations without departing from the spirit or scope of the invention. Thus, it is intended that the present invention cover such modifications and variations provided they come within the scope of the appended claims and their equivalents.

What is claimed is:

1. A method of fabricating a metal-insulator-metal (MIM) capacitor, the method comprising the steps of:
providing a substrate, the substrate having a dielectric layer formed thereon;
dry etching the dielectric layer to form one or more capacitor trenches therein;
wet etching the dielectric layer to round corners of the one or more capacitor trenches; and
forming in sequence a lower electrode, an insulator and an upper electrode over the dielectric layer and surfaces of the one or more capacitor trenches.

2. The method according to claim 1, wherein the dielectric layer is formed of silicon dioxide.

3. The method according to claim 2, wherein the wet etching is performed by using diluted hydrofluoric acid or buffered oxide etchant for 5 seconds to 10 minutes.

4. The method according to claim 2, wherein the dry etching is performed with a pressure of 1 mTorr to 10 mTorr, a source RF power of 100 W to 300 W, a bias RF power of 100 W to 300 W, an oxygen flow rate of 10 SCCM to 30 SCCM, a carbon tetrafluoride flow rate of 10 SCCM to 50 SCCM, a helium flow rate of 20 SCCM to 100 SCCM and a temperature of 40° C. to 50° C.

5. The method according to claim 1, wherein the lower electrode and the upper electrode are formed of copper or aluminum.

6. The method according to claim 1, wherein the insulator is formed of silicon dioxide or silicon nitride.

7. A metal-insulator-metal (MIM) capacitor fabricated by using the method according to claim 1, wherein the one or more capacitor trenches are round-cornered.

8. The MIM capacitor according to claim 7, wherein the lower electrode and the upper electrode are formed of copper or aluminum, and the insulator is formed of silicon dioxide or silicon nitride.
